(19) United States
(12) Patent Application Publication
(10) Pub. No.: US 2017/0342221 A1
(43) Pub. Date: Nov. 30, 2017

(54) POLYMER MASTER BATCH CONTAINING LINEAR, ULTRA HIGH MOLECULAR POLYDIMETHYLSILOXANES DEVOID OF VINYL GROUPS

(71) Applicant: Wacker Chemie AG, Munich (DE)

(72) Inventors: Michael GECK, Burghausen (DE); Oliver FUHRMANN, Altenmarkt (DE); Klaus POHMER, Munich (DE)

(73) Assignee: Wacker Chemie AG, Munich (DE)

(21) Appl. No.: 15/534,746

(22) PCT Filed: Nov. 30, 2015
(86) PCT No.: PCT/EP2015/078000

§ 371 Date: Jun. 9, 2017

(30) Foreign Application Priority Data
Dec. 12, 2014 (DE) 10 2014 225 685.2

(51) Int. Cl. C08J 3/22; C08L 23/12; C08L 83/04

(52) U.S. Cl. CPC C08J 3/22; C08L 83/04; C08L 23/12; C08J 2423/12; C08J 2383/04; C08J 2323/12; C08L 2310/00; C08J 2483/04

(57) ABSTRACT

Polymer masterbatches useful for producing polymer compositions with improved abrasion resistance include a polypropylene homopolymer and a polydimethylsiloxane having a molecular weight >200,000 g/mol and being free of vinyl groups.

### CROSS REFERENCE TO RELATED APPLICATIONS

This application is the U.S. National Phase of PCT Appin. No. PCT/EP2015/078000 filed Nov. 30, 2015, which claims priority to German Application DE 10 2014 225 685.2, filed Dec. 12, 2014 the disclosures of which are incorporated in their entirety by reference herein.

### BACKGROUND OF THE INVENTION

### 1. Field of the Invention

The invention relates to polymer masterbatches comprising linear, ultra-high molecular weight vinyl-free polydimethylsiloxanes and the use thereof as additives in the production of compounds.

### 2. Description of the Related Art

Admixtures or polymer compositions composed of polyolefins and organopolysiloxanes have long been known from the prior art by the term “masterbatch” or “blend” and are employed as additives or process auxiliaries in the production of thermoplastic organic polymer admixtures, the so-called “compounds”.

By way of example WO2014/044759A1 describes the production of blends of polyolefin and organopolysiloxane with a degree of polymerization of more than 4000 and at least 2 functional groups such as vinyl groups.

EP1153975B1 describes thermoplastic resin preparations, wherein two blends are used. The first blend consists of a thermoplastic resin and organopolysiloxane and the second blend is a thermoplastic resin which is chemically bonded to an organopolysiloxane comprising vinyl or other alkenyl groups.

EP0710692A2 describes a process for bonding polyorganosiloxanes to polypropylene. Polyorganosiloxanes having at least one silicone-bonded vinyl or other alkyenl radical are used therefor.

EP0826737B2 describes the modification of organic polymers with interactive diorganopolysiloxanes. These polysiloxanes have an average molecular weight Mn of at least 10,000 g/mol and comprise interactive groups such as hydroxyl, amino or vinyl groups.

EP0826727A1 describes a low density polyethylene modified with interactive diorganopolysiloxanes; these polysiloxanes have an average molecular weight Mn of at least 38,000 g/mol and comprise hydroxyl, amino or vinyl groups.

EP0722981A2 describes a polyolefin preparation comprising hydroxyl-functional diorganopolysiloxane having an average molecular weight of at least 10,000 g/mol.

U.S. Pat. No. 3,865,897 describes a process for producing blends of polyolefins and polydiorganosiloxanes, wherein high molecular weight polydimethylsiloxanes having vinyl groups are employed.

The masterbatches from the prior art are employed in the compounds as additives in order via the polysiloxane present therein to exert an influence on the performance characteristics of the compounds, for example reducing the coefficient of friction or increasing hydrophobicity, wear resistance, abrasion resistance or scratch resistance. However, the effect cannot always be achieved to the desired extent. There is therefore a need for further improvement in the performance characteristics of such compounds.

### SUMMARY OF THE INVENTION

The present invention accordingly has for its object the provision of a masterbatch for compounds which brings about an improvement in the performance characteristics of compounds, such as those mentioned above for example. This object was surprisingly achieved by the polymer masterbatch according to the invention, by preparing a master batch of a least one polypropylene homopolymer having a melt index of from 5-20 g/10 min. at 240° C. and 2.15 Kgs and of non-functional polydimethylsiloxane having a molecular weight of at least 200,000 g/mol.

### DETAILED DESCRIPTION OF THE PREFERRED EMBODIMENTS

The polymer masterbatches according to the invention thus comprise
A) at least one thermoplastic polypropylene homopolymer and
B) at least one linear polydimethylsiloxane having trimethylsilyl end groups

characterized in that
A) has a melt index of 5 to 20 g/10 min, measured at 230° C./2.16kg according to DIN ISO 1133, and
B) has an average molecular weight Mw of at least 200 000 g/mol and is free from vinyl groups.

The polymer masterbatch according to the invention preferably comprises 40-70 wt % of A) and 30-60 wt % of B), morepreferably 45-55 wt % of A) and 45-55 wt % of B).

The thermoplastic polypropylene homopolymer A) has a melt flow index (MFI) of 5-20 g/10 min. This is determined according to DIN ISO 1133 at 230° C./2.16 kg.

Component A) has long been obtainable in the form of commercial products. Depending on the method of production or the intended use, A) may already comprise the following additives, for example for stabilization thereof. These include processing and long-term stabilizers, such as phenolic antioxidants, phosphites, phosphonites, optionally synergists such as thioethers and acid acceptors such as Ca or Zn stearate. Such additives have long been known to those skilled in the art and are described for example in the textbook Gächter/Müller, Taschenbuch der Kunststoff-Additive 3rd edition, Hanser Verlag 1989; ISBN 3-4446-15627-5 on pages 50 et seq.

A) may be employed singly or as a mixture of at least 2 thermoplastic polypropylene homopolymers. A) is preferably employed singly.

Component B) is known to those skilled in the art and is commercially available. B) is a linear, methyl-functional ultra-high molecular weight polydimethylsiloxane having an average molecular weight of at least Mw 200,000 g/mol; preferably at least 300,000 g/mol, and preferably having a viscosity of preferably at least 10,000,000 mPas, more preferably at least 20,000,000 mPas.

B) may be employed singly or as a mixture of at least 2 linear, methyl-functional, ultra-high molecular weight polydimethylsiloxanes. B) is preferably employed singly.

Production of the polymer masterbatch according to the invention is effected by mixing A) and B) at a temperature at which both are present in the liquid phase. This may be effected for example in a commercially available, corotating twin-screw extruder such as is known to those skilled in the art. The value of the length/diameter ratio (L/D ratio) of these screws is preferably at least 30, more preferably at least 35.

The incorporation of component B) into the melt of component A) is preferably effected at temperatures of 150-250° C., more preferably at 170-230° C. After mixing, the polymer masterbatch is cooled, for example in a water bath. It may then be pelletized to facilitate further processing.

The polymer masterbatch according to the invention is used as an additive or process auxiliary in the production of thermoplastic compounds. It has become apparent that, surprisingly, surfaces of moldings for automobile interior applications made of polypropylene compounds and produced with polymer masterbatch according to the invention as an additive exhibit markedly better scratch resistance than surfaces of moldings produced according to the prior art using masterbatches comprising interactive organopolysiloxanes.

### EXAMPLES

The following example serve to elucidate the invention without restricting the invention. Unless otherwise stated the prevailing pressure is standard pressure of 1013 mbar.

### Examples for Production of Polymer Masterbatches

### Example 1 (Inventive)

Pelletized polypropylene homopolymer having a melt flow index of 12 g/10min (determined to DIN ISO 1133, at 230° C./2.16 kg), obtainable for example under the name MOSTEN® NB 112 from Unipetrol, Prague, Czech Republic, was gravimetrically metered in the feed region at a feed rate of 12 kg/h into a ZSE 27 HP twin-screw extruder from Leistritz, Nuremberg, Germany having a length/diameter ratio of 40 and a screw diameter of 27 mm. The average screw temperature was 170° C. to 210° C. Vinyl-free linear, ultra-high molecular weight polydimethylsiloxane having trimethylsilyl end groups and an average molecular weight of 533,000 g/mol (commercially available from Wacker Chemie AG, Munich, Germany under the name GENIOPLAST® Gum) was added to the polypropylene by metered addition in equal parts by weight, likewise at a feed rate of 12 kg/h. The extrudate was cooled in a water bath and pelletized. The content of ultra-high molecular weight polydimethylsiloxane was determined indirectly by elemental analytical silicon determination by Wurtzschmidt decomposition and gave a content of 48.2%.

### Example 2 (Inventive)

Pelletized polypropylene homopolymer having a melt flow index of 7 g/10min (determined at 230° C./2.16 kg), obtainable for example under the name MOSTEN® GB 107 from Unipetrol, Prague, Czech Republic, was gravimetrically metered in the feed region at a feed rate of 12 kg/h into a ZSE 27 HP twin-screw extruder from Leistritz, Nuremberg, Germany having a length/diameter ratio of 40 and a screw diameter of 27 mm. The average screw temperature was 170° C. to 210° C. Vinyl-free linear, ultra-high molecular weight polydimethylsiloxane having trimethylsilyl end groups and an average molecular weight of 533,000 g/mol (commercially available from Wacker Chemie AG, Munich, Germany under the name GENIOPLAST® Gum) was added to the polypropylene by metered addition in equal parts by weight, likewise at a feed rate of 12 kg/h. The extrudate was cooled in a water bath and pelletized. The content of ultra-high molecular weight polydimethylsiloxane was determined indirectly by elemental analytical silicon determination by Wurtzschmidt decomposition and gave a content of 47.9%.

### Example 3 (Noninventive)

A commercially available masterbatch is used as a comparative masterbatch: DOW CORNING® MB50-001 from Multibase (a Dow Corning Company); Saint Laurent du Pont, FRANCE. The masterbatch consists of 50% PP homopolymer having an MFI of 12 and 50% ultra-high molecular weight, dimethylvinyl-terminated PDMS (as per manufacturer specifications).

Production of Polypropylene Compounds

Four compounds (composition as per table 1) were compounded on a KraussMaffei Berstorff, (Hannover, Germany) ZE 25 twin-screw extruder having a length/diameter ratio of 47 and a screw diameter of 25 mm at a temperature of 185-190° C., a screw speed of 400 rpm and throughput of 10 kg/h. To this end all pelletized constituents were mixed to afford a dryblend and the dryblend was gravimetrically metered into the feed region of the extruder. Likewise all pulverulent constituents were mixed to afford a dryblend and this dryblend was likewise gravimetrically metered into the feed region of the extruder.

The resulting extrudate was cooled in a water bath and pelletized.

The following abbreviations correspond to the following reactants:

1. PP MIC=polypropylene medium impact copolymer, melt flow index 33 g/10min (230° C./2.16 kg) to DIN ISO 1133; from SABIC Europe, Sittard, Netherlands

2. POE=polyolefin elastomer; density 0.87 g/cm³, melt flow index 5 g/10min (190° C./2.16 kg) to DIN ISO 1133; from Dow Chemical Company, Midland, Mich., USA

3. Talc=talc from JetFine® 3CA from Imerys, Paris, France.

4. CBM=PLASBLAK® LL2590 from Cabot Corporation, Boston, Mass., USA

5. MB Ex. 1=masterbatch from example 1

6. MB Ex. 2=masterbatch from example 2

7. MB Ex. 3=masterbatch from example 3 (noninventive)

TABLE 1

Compound

| | | | |
|---|---|---|---|
| A | B | C | D |

| | |
|---|---|
| Constituent | Parts by weight |

| | | | | |
|---|---|---|---|---|
| 1. PP MIC | 67.2 | 67.2 | 67.2 | 67.2 |
| 2. POE | 10.0 | 10.0 | 10.0 | 10.0 |
| 3. Talc | 20.0 | 20.0 | 20.0 | 20.0 |
| 4. CBM | 2.0 | 2.0 | 2.0 | 2.0 |
| 5. MB Ex. 1 | — | 3.0 | — | — |
| 6. MB Ex. 2 | — | — | 3.0 | — |
| 7. MB Ex. 3 | — | — | — | 3.0 |
| 8. Calcium stearate | 0.2 | 0.2 | 0.2 | 0.2 |
| 9. antioxidant, UV | 0.6 | 0.6 | 0.6 | 0.6 |
| stabilizer | | | | |

Production of Injection Molded Sheets from Compounds A to D

The thus produced polypropylene compounds A to DL were used to manufacture injection molded sheets having a grained surface (representative for automotive interior application) and dimensions of 8 cm x 12 cm and a thickness of 2 mm on an Engel ES 600/125 injection molding machine at 190-250° C., an injection rate of 40 mm/s, a back pressure of 5 bar and a holding pressure of 25 bar.

Sheets A were manufactured from compound A.

Sheets B were manufactured from compound B.

Sheets C were manufactured from compound C.

Sheets D were manufactured from compound D.

Evaluation of the Surfaces of Injection Molded Sheets A to D for Scratch Resistance: Short-term Study

The injection molded sheets from A to D were stored for 2 days under standard environmental conditions of 23° C. and 50% relative humidity. After storage, a scratch hardness tester from Erichsen, Hemer, Germany (model 430 P-I) was used to apply scratches to the grained surfaces with a force of 10 N at a rate of 1000 mm/min. The tool used here had a rounded point with a diameter of 1 mm. In each case 20 parallel lines at a spacing of 2 mm were applied and, perpendicular thereto, a further 20 parallel lines at a spacing of 2 mm were then applied at a 90° angle, thus forming a grid-shaped scratch pattern. Scratch resistance was quantified by measurement of the difference in brightness between the scratched surface and the non-scratched surface on the same sheet in each case. The difference between the brightnesses (ΔL) was determined with a color and gloss measuring instrument from Erichsen, Hemer, Germany (model spectromaster 565-45). The results are summarized in table 2.

Evaluation of the Surfaces of Injection Molded Sheets A to D for Scratch Resistance: Long-term Study

The injection molded sheets made of A to D were stored for 7 days at 80° C. to achieve accelerated aging. After storage said sheets were evaluated as per the short-term study. The results are summarized in table 2.

TABLE 2

| Injection molded sheet | A | B | C | D |
|---|---|---|---|---|
| ΔL short-term study | 6.0 | 0.4 | 0.3 | 0.6 |
| ΔL long-term study | 4.6 | 0.1 | 0.0 | 0.6 |

The smaller the AL value the less visible the applied scratch pattern. Thus, the smaller the AL value the better the scratch resistance.

The results from table 1 show that the injection molded sheets B and C produced from compounds produced with inventive polymer masterbatches as per examples 1 and 2 show lower AL values and thus better scratch resistance is achieved.

1.-5. (canceled)

6. A polymer masterbatch, comprising:
A) at least one thermoplastic polypropylene homopolymer, and
B) at least one linear polydimethylsiloxane having trimethylsilyl end groups, wherein the thermoplastic polypropylene homopolymer A) has a melt flow index of 5 to 20 g/10 min, measured at 230° C./2.16kg according to DIN ISO 1133, and the linear polydimethylsiloxane B) has an average molecular weight Mw of at least 200,000 g/mol and is free from vinyl groups.

7. The polymer masterbatch of claim 6, comprising 40-70 wt % of A) and 30-60 wt % of B).

8. The polymer masterbatch of claim 6, comprising 45-55 wt % of A) and 45-55 wt % of B).

9. A process for producing a polymer masterbatch of claim 6, comprising mixing A) and B) at a temperature at which both are present in the liquid phase.

10. In a process for the preparation of a thermoplastic compound containing an additive or process auxiliary, the improvement comprising incorporating a polymer masterbatch of claim 6 as an additive or process auxiliary in the production of the thermoplastic compound.
